(19) United States
(12) Patent Application Publication
(10) Pub. No.: US 2003/0160923 A1
(43) Pub. Date: Aug. 28, 2003

(54) Full color cholesteric displays employing cholesteric color filter

(76) Inventor: Yao-Dong Ma, San Jose, CA (US)

Correspondence Address: Yao-Dong Ma, 14586 Pensham Dr., Frisco, TX, 75035, US

(21) Appl. No.: 10/078,801

(22) Filed: Feb. 19, 2002

(51) Int. Cl. G02F 1/1335

(52) U.S. Cl. 349/115

(57) ABSTRACT

The present invention relates to a liquid crystal display, more specifically, relates to a full color cholesteric display employing circularly polarized micro-color filter which is composed of polymeric cholesteric thin film. The display has a long time memory and excellent characteristics of brightness and contrast. A built-in cholesteric color filter structure provides a full color gamut of circular polarization. A cholesteric liquid crystal cell structure, as a circular polarization modulator, provides optical ON and OFF states respectively with its one texture as a circular polarizer and the other texture as a depolarizer. Both of those two textures are electric field controllable.

### FIELD OF THE INVENTION

The present invention relates to a liquid crystal display, more specifically, relates to a reflective full color cholesteric display employing reflective circularly polarizing micro-color filter which is composed of polymeric cholesteric thin film. The display has a long time memory and an excellent characteristics of brightness and contrast.

### BACKGROUND OF THE INVENTION

Liquid crystal display devices comprising polarizers and micro-color filter components are utilized in various flat panel displays. Reflective displays with full color capability are currently top-of-the-line products for portable electronics. Such reflective full color performance meets its basic requirement of high-information-content displays for a simple reason of less power consumption and thinner structure compared with the backlit counterparts. The typical reflective displays, nowadays, are reflective thin film transistor (TFT) display and reflective STN display. However, the overall performances of the reflective displays are still not as good as the transmissive backlit mode in terms of brightness, contrast ratio and viewing angle. And it is difficult to achieve the same contrast practically available for a transmission backlit display. These disadvantages result mainly from light-loss by the absorptive polarizers and from the angular dependency of the axis of polarization. In general, there is more than 60% optical loss. In the case of color display, light-loss is further aggravated due to the absorptive color filter which will cut off at least 60% incoming light. Current full color display is achieved by micro-color filter element made by organic dye or pigment which involves multiple patterning manufacturing process. It will take more challenge to produce the reflective color filter than that of the transmissive one.

U.S. Pat. No. 4,032,218 introduces a cholesteric color reflector and TN cell to display monochrome information on the black background. A quarter-wave plate is positioned between the cholesteric film and the TN display to convert circular polarization into linear polarization. A black coating is attached on the back of the device to absorb all the residual light passing from the cholesteric film. As a result, a viewer will sense a bright color light generated by the cholesteric color film on a black background.

U.S. Pat. No. 5,555,114 teaches cholesteric color selection layer, which selectively reflecting circularly polarized light of a specific wavelength and an optical layer formed on the color selection layer and having a liquid crystal and means for applying an electric field to the liquid crystal layer. A linear optical shifting layer on the top of cholesteric color filter convert circularly polarized light into linear polarization. This approach is not sufficient for a STN cell, a non-wave-guiding mode display, because of its non-linear optical performance due to the super twist dispersion to the incoming light The color is actually the combination of color dispersion of birefringence of display cell and Bragg reflection from cholesteric color selection layer In order to eliminate the color dispersion, the different voltage will apply to the different color pixels to convert the elliptical polarization into circular polarization, yet this make driving scheme very complicate or even impracticable.

U.S. Pat. No. 5,949,513 teaches a method of manufacturing a multi-color cholesteric display. The method include the steps of (1) deposition a twist agent on a first substrate, the twist agent becoming an in situ twist agent, (2) bringing a second substrate into proximity with the first substrate to form at least one interstitial region between the second and first substrates, (3) introducing liquid crystal having an initial pitch into the at least one interstitial region proximate the in situ twist agent and (4) stimulating the LC and the in situ twist agent to cause the LC and the in situ twist agent to mix in situ, the in situ twist agent to mix in situ, the in situ twist agent changing the initial pitch of the LC. A permanent polymer wall is necessary to isolate the LC of different pitch from flowing around. It is difficult to make defect-free product Furthermore, the color cholesteric display has different threshold voltage of each color due to the pitch difference which makes the driving very complicated.

### SUMMARY OF THE INVENTION

To address the above-mentioned deficiencies of the prior art, it is a primary object of the present invention to provide a full color reflective cholesteric display while maintaining the cholesteric display's superiority such as high environmental contrast ratio, hemispheric viewing angle, zero-field long time memory and so on.

It is another object of the present invention to provide the cholesteric liquid crystal cell structure as a circular polarization modulator, i.e., with its one texture as a circular polarizer and the other texture as a depolarizer. Both of those two textures are electric field controllable.

It is a further object of the present invention to provide a built-in cholesteric color filter with highly saturated circularly polarized color covering the whole visible wavelength. The cholesteric liquid crystal cell structure allows such a cholesteric film to be the coloring elements to reproduce a vivid image or displayable information.

It is again another object of the present invention to provide an ultra-thin cholesteric coloring element positioned on the top of the conductive patterning and inside the display cell, thus simplifies the display manufacturing process.

It is still a further object of the present invention to provide a transflective cholesteric color filter structure, which is capable of reflecting a full gamut visible circular polarization with one polarity and of transmitting a full gamut visible circular polarization with the other polarity.

It is another object of the present invention to provide a dual-working mode color display. During the day or in a bright ambient light, the display works as a reflective display while during the night or in a dark ambient light condition, the display works as a transmissive backlit display.

It is again another object of the present invention to provide an overhead color projector with no absorptive polarizing component, which will be able to be used in a normal transparence presentation.

It is a further object of the present invention to provide an ultra-compact, power-saving portable color projector without any dichroic and absorptive components.

It is still another object of the present invention to provide a circular polarizer on the top of the display to enhance the color purity and contrast ratio of the display.

It is still a further object of the present invention to provide an optical compensation solution to the color shift of the cholesteric color filter by means of the infrared Bragg reflection of controllable cholesteric cell structure.

It is the final object of the present invention to provide a manufacturing process to produce a built-in cholesteric color filter in a mass production scale.

In the attainment of the above-described objects, the present invention provides a essential display cell structure including two cholesteric layers: (1) cholesteric light shutter which generates optical “on” state and optical “off” state; (2) cholesteric coloring element which generates R, G and B primary colors for the display shutter.

### BRIEF DESCRIPTION OF THE DRAWINGS

FIG. 1 illustrates a schematic reflective display structure and its light reflective behavior.

FIG. 2 illustrates another schematic reflective display structure and its light behavior.

FIG. 3 illustrates a schematic sectional drawing of the full color cholesteric display.

FIG. 4 illustrates another schematic sectional drawing of the full color cholesteric display.

FIG. 5 illustrates a front light and back light dual-working mode full color display.

FIG. 6 illustrates a display mode without utilizing circular polarizer.

FIG. 7 illustrates a full color CLC projection display.

FIG. 8 illustrates a schematic drawing of a color CLC portable projector.

FIG. 9 illustrates a schematic drawing of CCF manufacturing process.

FIG. 10 illustrates a schematic drawing of another CCF manufacturing process.

### DETAILED DESCRIPTION

Referring first to FIG. 1, illustrated is the schematic reflective display structure and its light reflective behavior. A cholesteric cell structure 110 includes a controllable planar texture 111 and controllable focal conic texture 112. A circular polarizer plate 120 locates above the cholesteric cell structure, which may or may not directly touch to it. A cholesteric micro color filter 130 directly attaches to the cholesteric cell structure. The optical handedness of those components 110, 120 and 130 are arranged in such a way that the cholesteric cell structure 110 has opposite handedness to the circular polarizer (CP) 120, and to the cholesteric color filter (CCF) while the CCF has the same handedness as the CP. For example, if the CP and the CCF are chosen as right-handed (RH) then the cholesteric cell structure will be containing left-handed (LH) cholesteric liquid crystal (CLC) material.

The CLC material in controllable planar texture has an intrinsic visible wave bend 152 due to Bragg reflection. However, the intrinsic reflection will be cut off completely by the opposite-handed front CP 120. In other words, the color from the cholesteric cell structure is non-displayable. On the contrary, the Bragg reflections 151 from the polymeric CCF layer will penetrate all the way through the cholesteric cell and through the front CP without substantial attenuation, and then emerge towards an observer as vivid bright colors 153.

The light path in display's planar texture can be described as follows: The incoming light ray 140 passing through the front CP 120 becomes RH polarized light 141 with the intensity less than half of the origin. Because of its opposite handedness, light 141 further passing through CLC's planar texture becomes light 142 without substantially changing its polarity and intensity. When light 142 reaches to CCF, it will be Bragg reflected by each individual red 133, green 131 and blue 132 sub-pixel, and becomes color light 143. All the non-reflected light wave bend will be absorbed by the black coating 134 on the back side of the CCF. The color light 143 then passes through the CLC planar texture (see light 144) and CP, and finally becomes out-coming linear polarization 145.

On the other hand, when the light 141 hits on the CLC's focal conic texture, it will substantially become depolarized light 146. All those lights, including newly generated LH component and non-selective reflected RH wave bend, will pass through the CCF and be absorbed by the black coating 134 on the back side of the CCF. Only a small portion of the selected RH light 147 will be bounced back and depolarized again in the CLC's focal conic texture (see light 148). The depolarized light 148 then passes through the front CP with the cost of more than 50% loss. Note that the scattering effect in CLC's focal conic texture not only depolarizes the light but changes the light direction as well. The remaining light will be further attenuated by the interfacial surface-reflection. As a result, only less than 2% of the total incoming light has a chance to reach back in the CLC's focal conic texture area.

In terms of contrast ratio, assuming the CP has 45% transmission, then the maximum reflectivity in planar texture will be 15%; and maximum reflectivity in focal conic texture will be 2%. Those skilled in the art create a full color reflective display with contrast ratio 7:1 if the surface reflection is properly taken care of.

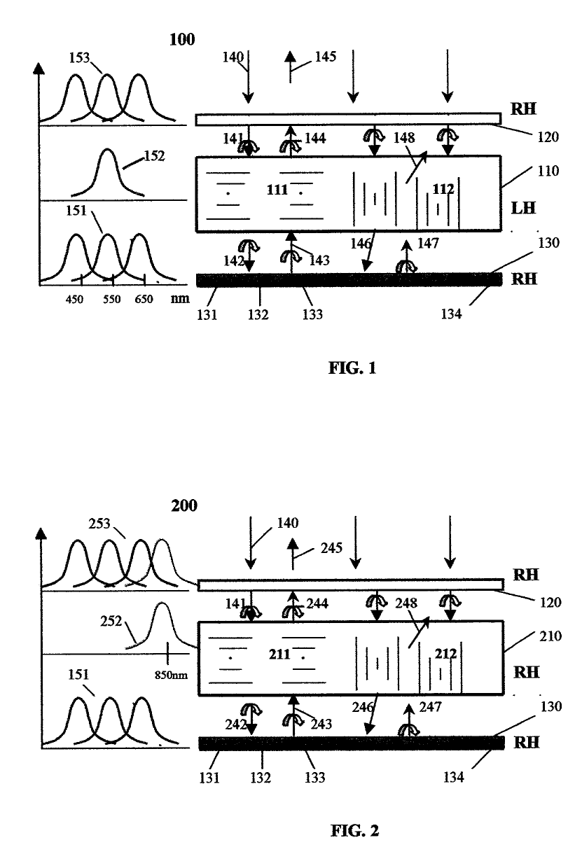

Turning now to FIG. 2., illustrated is another schematic reflective display structure and its light behavior. A cholesteric cell structure 210 includes a controllable planar texture 211 and controllable focal conic texture 212. A circular polarizer plate 120 locates above the cholesteric cell structure, which may or may not directly touch to it A cholesteric micro color filter 130 directly attaches to the cholesteric cell structure. The handedness of those component 210, 120 and 130 are arranged in such a way that the cholesteric cell structure 210 has the same handedness as both the CCF and CP. For example, all the components 120,210 and 130 have the right-handed polarity. The CLC material in controllable planar texture has an intrinsic invisible wave bend when illuminated and viewed almost vertical to the display surface. But it may become visible when viewed or illuminated aberrant to the normal direction. The central Bragg reflection wavelength is chosen in an infrared wave bend, for example, 700˜1500 nm, more preferably, 750˜850 nm. The out-coming wave-bend 253 will be a composition of a visible wave bend 151 from CCF and an invisible wave bend 252 from CLC's planar texture.

The light path in display's planar texture can be described as follows: The incoming light ray 140 passing through the front CP 120 becomes RH polarized light 141 with the intensity less than half of the origin. Light 141 further passing through CLC's planar texture becomes light 242 without substantially changing its polarity and intensity. When light 242 reaches to CCF, it will be Bragg reflected by each individual red 133, green 131 and blue 132 sub-pixel, and becomes color light 243. All the non-reflected light wave bend will be absorbed by the black coating 134 on the back side of the CCF. The color light 243 then passes through the CLC planar texture (see light 244) and CP 120, and finally becomes out-coming linear polarization 245.

On the other hand, when the light 141 hits on the CLC's focal conic texture, it will substantially become depolarized light 246. All those lights, including newly generated LH component and non-selective reflected RH wave bend, will pass through the CCF 130 and be absorbed by the black coating 134 on the back side of the CCF 130. Only a small portion of the selected RH light 247 will be bounced back and depolarized again in the CLC's focal conic texture (see light 248). The depolarized light 248 then passes through the front CP 120 with the cost of more than 50% loss. Note that the scattering effect in CLC's focal conic texture not only depolarizes the light but changes the light direction as well. The remaining light will be further attenuated by the interfacial surface-reflection. As a result, only less than 2% of the total incoming light has a chance to reach back in the CLC's focal conic texture area.

The advantage of utilization of CLC's near infrared reflection is that, to a certain extent, it compensates the color shift when it is viewed or illuminated at a oblique angle and enhances red color saturation of CCF. In the field of cholesteric color filter technology, there are two fundamental problems regarding the optical performances. Firstly, angular color dispersion due to the fact that the wavelength (λ) of the Bragg reflection has dependency to the viewing angle (θ),

λ=n p cos θ

where “n” represents the average refractive index and “p” the pitch of CLC material. When the light is illuminating at a normal angle to the display surface but it is viewed from an oblique angle θ, the wavelength λ will be getting smaller. This is so called short-wavelength-color shift. Secondly, the brightness of red color is always not as good as the green and blue one due to the less twisting power of cholesteric domains in the red region. The addition of the infrared color from CLC's planar texture will not only be able to enhance the brightness of the display but also to maintain the neutral color-reproduction reproduction when viewed at an oblique direction. The latter, obviously enlarges viewing angles of the display.

There is another color dispersion, temperature induced color change in the prior art cholesteric technology This is a common issue in U.S. Pat. No. 5,949,513 and U.S. Pat. No. 6,285,434 where the R.G.B colors are directly generated from the controllable CLC planar texture. Those skilled in the art, however, generates them from polymeric cholesteric coloring film. The color of CCF has already been locked up after polymerization during a manufacturing process. The CLC planar texture, now, becomes a circularly polarized light modulator of the cholesteric color filter.

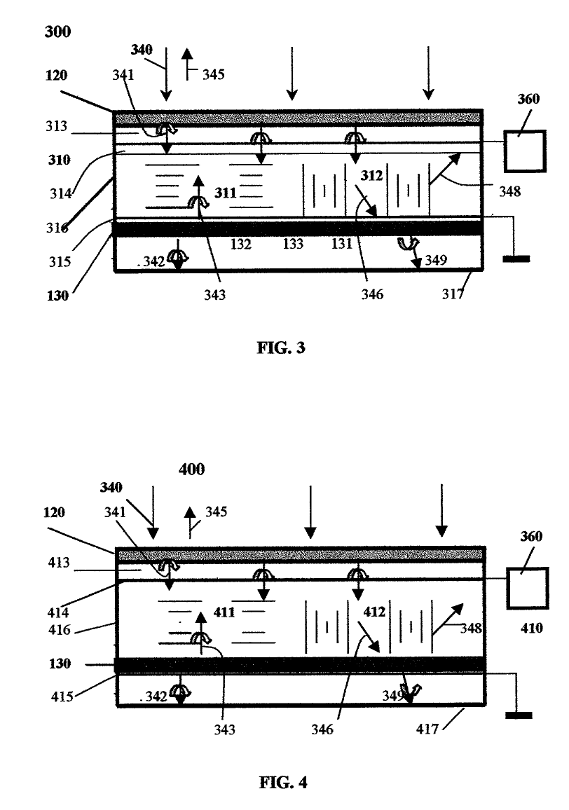

Turning now to FIG. 3, illustrated is a schematic sectional drawing of the full color cholesteric display. It consists of a display cell 310, a front circular polarizer (CP) 120 and a CCF 130. The cell 310 is a basic structure of liquid crystal display, where a CLC material with controllable planar texture 311 and controllable focal conic texture 312 are sandwiched between two patterned conductive substrates 314 and 315 (either glass or plastic), and isolated by a polymeric ring 316. The cell gap, which is predetermined by a spacer material, micro-balls or bars, is in the range of 1 to 10 micrometers A thin polymer layer may be coated onto the inside of surfaces of the substrates to align the liquid crystal molecules in a specific way An electronic waveform 360 needs to connect to the conductive lead of the cell. The transparent conductive ITO patterning 315 is structured on the top of the CCF layer 130. Because of the intrinsic stability of the cholesteric focal-conic texture and planar texture, no further alignment layer is necessary on bottom ITO patterning, and the CLC material will directly contact with the conductive ITO electrodes 315. A black coating layer 317 is attached on the back of the display structure.

The light path in display's planar texture can be described as follows: The incoming light ray 340 passing through the front CP 120 becomes RH polarized light 341 with the intensity less than half of the origin. Light 341 further passes through CLC's planar texture without substantially changing its polarity and intensity. When light 341 reaches to CCF, it will be Bragg reflected by each individual red 133, green 131 and blue 132 sub-pixel, and becomes color light 343. All the non-reflected light 342 will be absorbed by the black coating 317 on the back side of the display. The color light 343 then passes through the CLC planar texture and CP 120, and finally becomes out-coming linear polarization 345.

On the other hand, when the light 341 hits on the CLC's focal conic texture, it will substantially become depolarized light 346. All those lights, including newly generated LH component and non-selective reflected RH wave bend 349, will pass through the CCF 130 and be absorbed by the black coating 317 on the back side of the display. Only a small portion of the selected RH light 348 will be bounced back and depolarized again in the CLC's focal conic texture. The depolarized light then passes through the front CP 120 with the cost of more than 50% loss. Note that the scattering effect in CLC's focal conic texture not only depolarizes the light but changes the light direction as well. The remaining light will be further attenuated by the interfacial surface-reflection. As a result, only less than 2% of the total incoming light has a chance to reach back in the CLC's focal conic texture area.

Turning now to FIG. 4, illustrated is another schematic sectional drawing of the full color cholesteric display. It consists of a display cell 410, a front circular polarizer (CP) 120 and a CCF 130. The cell 410 is a basic structure of liquid crystal display, where a CLC material with controllable planar texture 411 and a controllable focal conic texture 412 are sandwiched between two patterned conductive substrates 414 and 415 (either glass or plastic), and isolated by a polymeric ring 416. The cell gap, which is predetermined by a spacer material, micro-balls or bars, is in the range of 1 to 10 micrometers A thin polymer layer may be coated onto the inside of surfaces of the substrates to align the liquid crystal molecules in a specific way. An electronic waveform 360 needs to connect to the conductive lead of the cell. The transparent conductive ITO patterning 415 is structured underneath of the CCF layer 130. Because of the intrinsic stability of the cholesteric focal-conic texture and planar texture, no further alignment layer is necessary, and the CLC material will directly contact with the CCF layer 130. A black coating layer 417 is attached on the back of the display structure.

The light path in display's planar texture can be described as follows: The incoming light ray 340 passing through the front CP 120 becomes RH polarized light 341 with the intensity less than half of the origin. Light 341 further passes through CLC's planar texture without substantially changing its polarity and intensity. When light 341 reaches to CCF, it will be Bragg reflected by each individual red 133, green 131 and blue 132 sub-pixel, and becomes color light 343. All the non-reflected light 342 will be absorbed by the black coating 417 on the back side of the display. The color light 343 then passes through the CLC planar texture and CP 120, and finally becomes out-coming linear polarization 345.

On the other hand, when the light 341 hits on the CLC's focal conic texture, it will substantially become depolarized light 346 All those lights, including newly generated LH component and non-selective reflected RH wave bend 349, will pass through the CCF 130 and be absorbed by the black coating 417 on the backside of the display. Only a small portion of the selected RH light 348 will be bounced back and depolarized again in the CLC's focal conic texture. The depolarized light then passes through the front CP 120 with the cost of more than 50% loss. Note that the scattering effect in CLC's focal conic texture not only depolarizes the light but changes the light direction as well The remaining light will be further attenuated by the interfacial surface-reflection. As a result, only less than 2% of the total incoming Light has a chance to reach back in the CLC's focal conic texture area.

The difference from FIG. 3 is that the CCF 130 is deposited on the top of the transparent conductive layer, which makes the manufacture process much simpler The color filter is designed in the range of 1.2˜3μ, more preferably 1.5˜2.0μ.

| | R | G | B |
|---|---|---|---|
| λ₀ | 650 | 550 | 450 |
| n | 1.5 | 1.5 | 1.5 |
| P | 0.43 | 0.37 | 0.3 |
| D/P | 3 | 3.2 | 4 |

The average reflectivity for blue will reach 95% of the heoretical data while the red will reach approximately 80% of the theoretical data.

In this case, red color compensation from the CLC planar texture is necessary. The increasing of driving voltage due to the voltage drop of CCF can be compensated to a certain extent by the infrared cholesteric cell structure. It is practical to use normal STN driver with the working voltage of 42V.

If the thickness of CCF 130 is designed at 2.0μ, the DIP value then will become Red 4.65, Green 6.6. Now, Green and Blue have been reached to their theoretical saturation and Red color will also get to the 98% of maximum reflectivity. Considering the voltage drop of CCF, the CLC cell thickness should be less than 3μ and the intrinsic pitch of CLC should be in the infrared wavelength, for example, 850 nm The actual driving voltage will be then less than 50 volts, which is within the scope of a normal design of CMOS driver ICs.

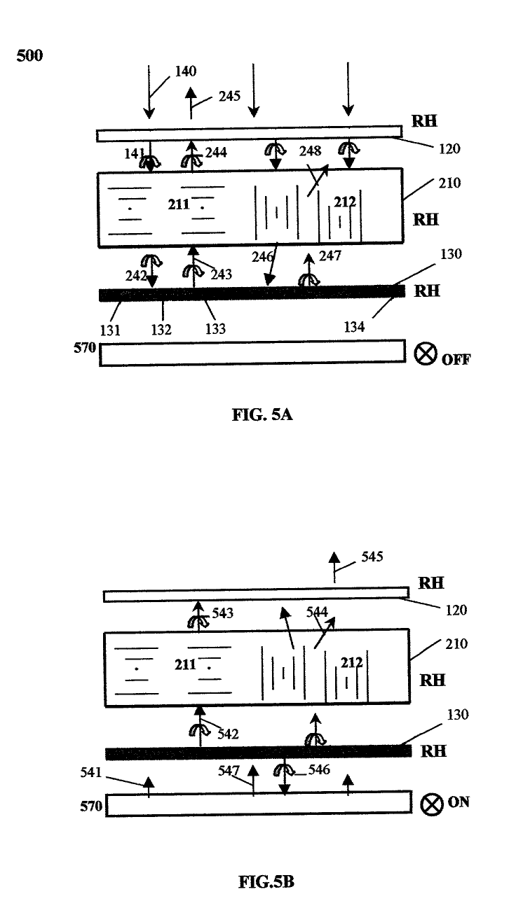

Turning now to FIG. 5, illustrated is a dual-working mode full color display. During the daytime, the display, as depicted in FIG. 5A, is similar to FIG. 2 in terms of optic “on” and optic “off” states. What is different from FIG. 2 is that we add liquid crystal dyes in the cholesteric liquid crystal color filter cells. For example, a red dye is added in the reflective red color cell, green dye in reflective green color, and blue dye in the reflective blue color cell correspondingly. The concentration of the dichroic dye in CCF is normally in the range of 1˜3%. The addition of red dye to the cholesteric color filter ensures red light reflection and transmission while cutting off the rest visible light, i.e. “green” and “blue” light. Similarly, the addition of green dye to the cholesteric color filter ensures green light reflection or transmission while cutting off the red and blue light. So does the blue dye. Therefore, the dual-purpose color filter, in the present invention, can be used for either reflective full color display or transmissive full color display.

A cholesteric cell structure 210 includes a controllable planar texture 211 and controllable focal conic texture 212. A circular polarizer plate 120 locates above the cholesteric cell structure, which may or may not directly touch to it. A cholesteric micro color filter 130 directly attaches to the cholesteric cell structure. The handedness of those component 210, 120 and 130 are arranged in such a way that the cholesteric cell structure 210 has the same handedness as both the CCF and CP. For example, all the components 120, 210 and 130 have the right-handed polarity. The CLC material in controllable planar texture has an intrinsic invisible wave bend when illuminated and viewed almost vertical to the display surface. But it may become visible when viewed or illuminated aberrant to the normal direction The central Bragg reflection wavelength is chosen in an infrared wave bend, for example, 700˜1500 nm, more preferably, 750˜850 nm. The out-coming wave-bend 253 will be a composition of a visible wave bend 151 from CCF and an invisible wave bend 252 from CLC's planar texture.

The light path in display's planar texture can be described as follows. The incoming light ray 140 passing through the front CP 120 becomes RH polarized light 141 with the intensity less than half of the origin. Light 141 further passing through CLC's planar texture becomes light 242 without substantially changing its polarity and intensity. When light 242 reaches to CCF, it will be Bragg reflected by each individual red 133, green 131 and blue 132 sub-pixel, and becomes color light 243. All the non-reflected light wave bend will be absorbed by the dark room between the CCF 130 and backlit panel 570. The color light 243 then passes through the CLC planar texture (see light 244) and CP 120, and finally becomes out-coming linear polarization 245.

On the other hand, when the light 141 hits on the CLC's focal conic texture, it will substantially become depolarized light 246 All those lights, including newly generated LH component and non-selective reflected RH wave bend, will pass through the CCF 130 and be absorbed by the dark room between the CCF 130 and back-lit panel 570. Only a small portion of the selected RH light 247 will be bounced back and depolarized again in the CLC's focal conic texture (see light 248). The depolarized light 248 then passes through the front CP 120 with the cost of more than 50% loss. Note that the scattering effect in CLC's focal conic texture not only depolarizes the light but changes the light direction as well. The remaining light will be further attenuated by the interfacial surface-reflection. As a result, only less than 2% of the total incoming light has a chance to reach back in the CLC's focal conic texture area.

FIG. 5B shows schematic principle of a transmissive full color display. When the black-lit 570 is in “on” state, neutral light 541 from the light-guide plate passing through color filter 130 becomes left-handed color light 542. Three primary colors, red, green and blue, are generated from the corresponding red, green and blue color microstructure. The light 542 proceed passing through the CLC's planar texture without changing its polarity (LH) and amplitude (see 543), and finally extinct by the RH front circular polarizer. The display is in optic “off” state.

On the other hand, when light 542 passing through the CLC's focal-conic texture, it becomes depolarized color light 544. However, color information determined by the controllable CLC matrix and color filter still remains in the light 544. Finally, light 544 passing through the front CP 120 becomes emerging light 545.

Note that the full color transmissive image is a reverse mode image relative to the reflective mode. The optic “on” state area in the reflective mode becomes now optic “off” state area in the transmissive mode; and the optic “off” state area in the reflective mode becomes now optic “on” state area in the transmissive mode. Unlike the prior art's pure absorptive color filter, the novel color filter has a light recycle function. The RH light 546 reflected from the CCF hits on the backlit system 570 and becomes depolarized light 547. Then it moves forward along with light 541. As a result, the light 545 have a brighter appearance than the prior art.

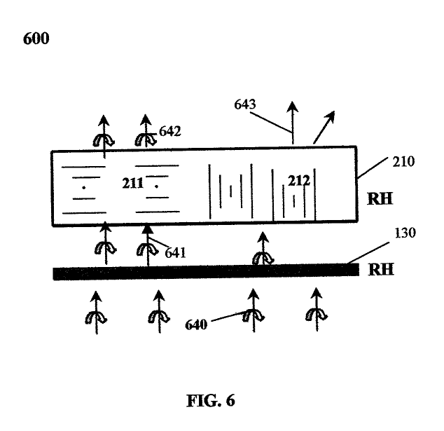

Turning now to FIG. 6, illustrated is another CLC display mode without circular polarizer. The CLC material has an intrinsic infrared Bragg reflection. The display is based upon backlit illumination. When a collimated circularly polarized light 640 passes through cholesteric color filter with the same handedness, three primary colors, red, green and blue circularly polarized light 641 are generated respectively. The light 641 further passes through the CLC's controllable planar texture area, maintaining its polarity and amplitude. Finally a circular polarized light 642 appears at front of the display.

On the other hand, when the light 641 passes through the CLC's controllable focal-conic texture area, it will become scattered depolarized light 643. The above-mentioned two optical states, collimated polarized state and scattered depolarized state, are very useful for projection applications.

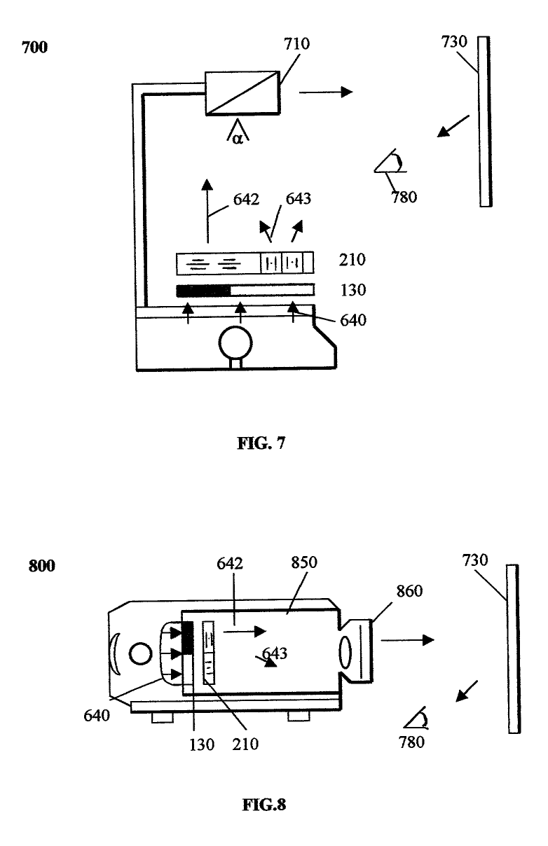

Turning now to FIG. 7, illustrated is a full color CLC projection display 700 employing the principles of the present invention. The full color CLC projection display 700 includes a controllable CLC structure 210 and a cholesteric color filter 130 which located proximate to the controllable CLC cell structure 210 and which has a similar handedness to that of the CLC cell structure. The color filter 130 is a pattern of Bragg reflective yellow, cyan and magenta (“YCM”) region corresponding to individual cells of the controllable CLC structure 210.

The operation of the full color CLC projection display 700 is similar to that of the front-lit full color CLC display 200; the difference being that the image perceived by a viewer is produced by the light transmitted through the display rather than reflected therefrom. The full color CLC projection display 700 is preferably illuminated by a light source 640, a circularly polarized white light with the same polarity as the CCF.

When the collimated circularly polarized 640 pass through CCF, the portion of Bragg reflection including yellow, cyan and magenta will reflect backward, and the red, green and blue, three primary colors will emit forward from the corresponding cell regions. When the CLC 210 is in an “on” state, the light passes through the controllable planar area and it will maintain its polarity and amplitude. The transmitted light 642 is projected by overhead projector 710 onto screen 730 where it is perceived by an observer 780.

When the CLC 210 is in an “off” state, the light passed through the controllable focal conic area is optically scattered and depolarized by the CLC 210. The portion 643 of the forward-scattered light is emitted from the controllable CLC's focal conic texture at wide angle. The collection angle œof the overhead projector 710, however, is generally narrow, resulting in only an insubstantial portion of the forward-scattered light 643, which is projected onto the screen 730. Thus, for the region of CLC's focal conic texture of the full color CLC projection display 700, a substantial portion of the incident light is not perceived by an observer, thus yielding a display with a high contrast ratio.

What is different from the prior art is that those skilled in the art eliminate the utilization of the absorptive circular polarizer. Thus offers the projection display ultra high brightness and allows the overhead projector to do a traditional transparency presentation when the whole CLC panel is in an “on” state.

Turning now to FIG. 8, illustrated is a schematic drawing of a color CLC portable projector 800, employing the principles of the present invention. The color CLC portable projector 800 includes a controllable CLC cell structure 210, a CCF 130, a black wall housing 850, backlit system 640 and projection lens 860. The operation of the color portable projector is identical to that of the color overhead projector 700. The only difference is that the addition of the black wall housing 850 provides the integrity of the portable device. The function of black wall housing is to absorb the forward-scattering light emitted from the focal conic texture area of the controllable CLC structure.

A most advantageous point of such portable projector over the prior art is that there are no any absorptive optical components, such as filter and polarizer which involved in the traditional TFT-TN projectors. The design of non-absorptive CCF filter and non-absorptive CLC light modulator enables the smallest projector with the brightest projection image.

Brightness is the primary specsmanship measure of a projector. For years “more brightness” has been the goal of manufacturers around the world. More technically, brightness is the consumer term for the luminance in a projected image that is responsible for the highlight area of that image to have a high contrast with the darkest areas. It is almost universally measured in ANSI lumens on the nine-point grid. A projector can never make the dark parts of a project image any blacker than they already are when the project is off, and the ambient room light is on. However, by making the highlights in the image brighter than the contrast ratio still can be impressive. Because of the high brightness, CLC projector can overcome some ambient light to maintain an impressive contrast ratio.

The other advantage of the CLC portable projector is its superior color purity. In video projections, much more is at stake with accurate color reproduction, color gamut is a primary goal of course. One must be able to accurately reproduce all the colors of real life as accurately as possible for realism. Unfortunately CRT phosphors have limited deep red reproduction, for so long it is now part of our color standards for video reproduction to have a somewhat orange-red displayed in place of deep red. Cholesteric colors, on the other hand, have wider gamut and a larger triangle area in the CIE diagram. This is because of the fact that the cholesteric color is coming from Bragg reflection of the natural light, thus the R.G.B primary colors are the purest ones than any other colorant agents. Therefore, CLC projector gives out almost truthful color reproduction.

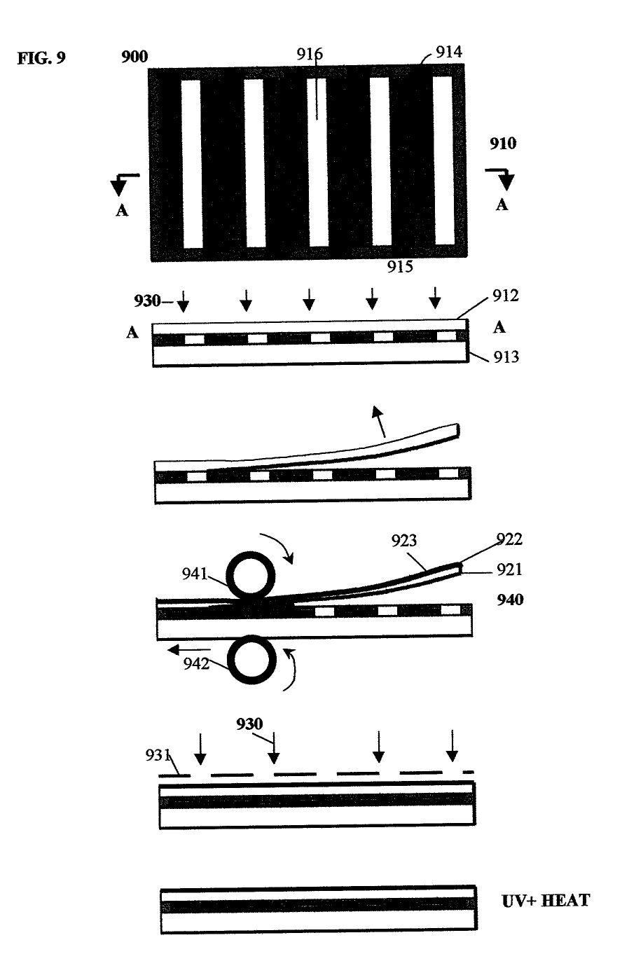

Turning now to FIG. 9, illustrated is a CCF manufacturing-process 900. The CCF manufacturing process includes the following steps:

Step 1. Build-Up Fill Channel Structure 910

The fill channel structure consists of a permanent substrate 911, a temporary substrate 912 and a polymeric wall material 913. There are two open channel groups 914 and 915 along the opposite direction of the CCF substrate. There is a non-filling channel group 916 enclosed in the channel structure. The polymeric wall material also works as a spacer that determines the thickness of CCF A programmable ink-jet dispenser is a good tool to construct the wall configuration. The height and width of the wall are usually in the range of 5˜10μ and 15˜25μ, respectively. The polymeric wall material 913 can be UV curable glue which is polymerized under UV exposure machine after the permanent substrate 911 and the temporary substrate 912 have been properly laminated together.

Step 2. Fill-In The CCF Pre-Polymer Formulation

The opening channel group 914 is filled with first primary color formulation, for example, red color, under vacuum and cured by a UV beam 930 as soon as the completion of filling. Then, the opening channel group 915 is filled with the second primary color formulation, for example, green color, under the same conditions as the first one, and then cured by UV exposure. The first and the second filling process can be carried out simultaneously at a vacuum filling chamber, and cured afterward at the same chamber.

The temporary substrate 912 and the permanent substrate 911 also work as alignment layers during the filling process that ensures the CCF formulation aligned in a good planar texture before being polymerized.

Step 3. Delaminate The Temporary Substrate

The temporary plastic substrate 912 is delaminated or released from the permanent glass substrate 911. The polymerized first and the second CCF material is left on the permanent substrate 911 and the third CCF channel 916, now, is opening to the air.

Step 4. Laminate Of The Third Primary Color Formulation.

A laminator 940 carries out the third CCF primary color formulation. A pair of nip rubber rollers 941 and 942 is designed with durability of 45˜50 and adjustable gap control mechanism. The laminator also has a registration and speed control system. A transparent conductive film 921 with ITO layer 922 face up and protective layer 923 attached on the surface of ITO layer 922. The third primary color formulation is applied to the front edge of the bottom substrate by a linear motion of a dispenser The registered conductive film 921 then is gently touched down to the top of CCF material while moving through the rubber nip of the laminator 940. The third CCF primary color formulation is spread out between the substrates and filled exactly in the channel 916. The speed of lamination is set at 0.7˜1 ft/second to remove any possible air bubbles in the channel.

Step 5. UV Cure The Third Primary Color

The third primary color, for example, blue color is cured by UV beam 930 under a photo mask 931 ensuring the curing window is corresponding exactly to the channel group 916. Finally, an overall UV exposure is necessary to cure the remaining uncured monomer above its clearing temperature, at which the material on the top of the channels 914 and 915 will become “color-less” transparent after curing.

It is also applicable that during the step 3, the delamination can be immediately executed by dispensing the third primary color formulation and laminated again with the same plastic substrate. The masking exposure can be followed once the third primary color formulation has completely filled into the channel 916. The temporary substrate then is peeled off from the CCF layer. The remaining uncured third primary color material is then cleaned up on a spin cleaner. Finally, a composite film, including ITO conductive film 922 with the thickness in 25˜50μ and a protection liner film 923 with the thickness in 50˜75μ, are laminated on the CCF by an UV-cured adhesive. The protective liner film 923 is disregarded when the ITO substrate is ready for the patterning process. Such alternative process is especially useful for the dual-working mode CLC display introduced in FIG. 5, where a dichroic dye is dissolved into the cholesteric monomer formulation. In this way, there will be no any possible dye residue from the third primary color left on the top of the first and second primary color layer.

Here comes an example regarding the specifications of the material. The wall material 913 is a black colored material, made of epoxy or polyacrylate. The temporary film is a polyester film with the thickness of 75˜125μ. The ITO coated film is an isotropic polymer film with the thickness of 25˜50μ. And the permanent substrate 911 is a polished glass with the thickness of 0.5˜1.1 mm.

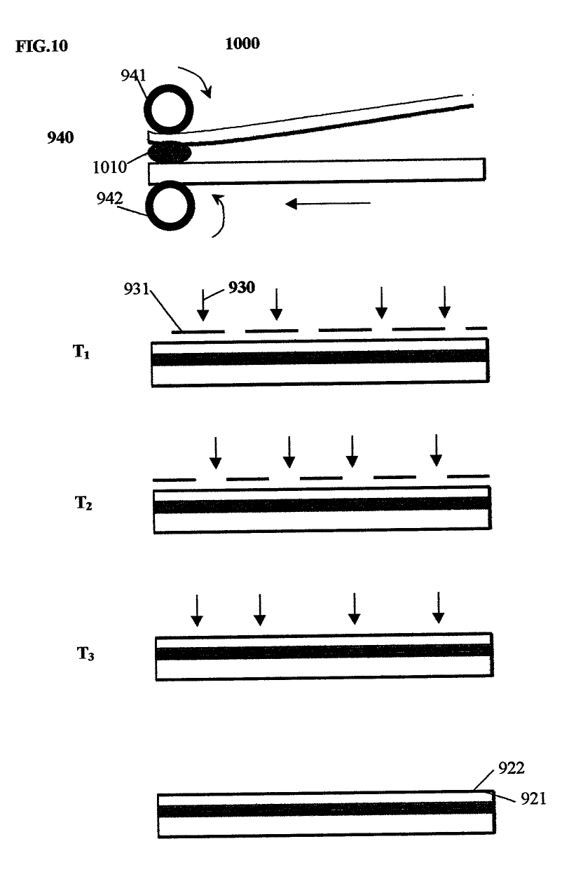

Turning now to FIG. 10, illustrated is a schematic drawing of another CCF manufacturing process. A cholesteric CCF pre-polymer mixture is made of CLC pre-polymer, chiral nematic LC, polymeric spacer, UV initiator and so on. The viscosity of the mixture is adjusted in the range of 300˜500 CP. The optimal percentage of the spacer material is in the range of 0.15˜0.2%.

A laminator 940 carries out the application of CCF pre-polymer mixture. A pair of nip rubber rollers 941 and 942 is designed with durability of 45˜50 and adjustable gap control mechanism. The laminator also has a registration and speed control system. The mixture 1010 is applied on the front edge of glass substrate by a linear moving dispenser. The ITO conductive film 921 is laid on the top of CCF material while moving through the rubber nip of the laminator 940. The CCF pre-polymer mixture is spread out between the two substrates with the thickness determined by the spacer. The color tint of the CCF pre-polymer has a non-linear dependence of temperature because both the pitch and Δn are the variables of temperature. When the sandwiched structure is moved on the heating stage and the temperature is raised incrementally, three primary colors will appear at three-temperature points T₁, T₂ and T₃. A photo mask 931 is registered to the first color area on the top of the sandwiched structure and underneath of an UV exposure machine. As the temperature reaches T₁, the UV exposure machine will be turned “on” and started to expose the window area. The CCF pre-polymer material in the exposed area will become polymerized, thus the first color has been fixed because the mixture in the exposed area has already been out off liquid crystal phase and the pitch has been locked by the CLC polymeric structure. The photo mask 931 then is registered to the second color area. When the temperature is adjusted at T₂, the UV exposure machine will be turned “on” and started to expose the second window area. Thus the second color has been fixed. The photo mask 931 may or may not be registered to the third color area When the temperature is adjusted at T₃, the UV exposure machine will be “on” and expose the area thus the third color has been fixed. After the three consecutive exposures, the three primary color arrays will be formed at the CCF layers.

The ITO conductive layer is then followed by a patterning process in a normal LCD production line until a complete full color CLC display is finished.

The ITO conductive patterning may also be pre-made on the bottom glass substrate. Now, the top plastic layer becomes a temporary alignment film. After completion of the CCF structure as mentioned above, the top plastic layer can be removed and the CCF layer will directly contact the CLC material as described in FIG. 4.

I claim:

1. A full color reflective display comprising:
a. a circular polarizer with a predetermined polarity,
b. a solid cholesteric coloring patterned film with a predetermined polarity,
c. a plurality of transparent conductive patterned substrates juxtaposed to form a cell structure,
d. a cholesteric liquid crystal material with a predetermined polarity and wave bend and with a controllable planar texture and a controllable focal conic texture respectively,
wherein the cell structure, including the cholesteric liquid crystal material, is laminated with its viewing side surface onto the circular polarizer, while the solid cholesteric coloring film is positioned to the inside of the transparent conductive patterned substrate opposite to the viewing side with the color pattern corresponding to the conductive pattern of the substrate,
whereby at least one primary color will be displayed in the controllable planar texture area of the display and an optical dark state will be displayed in the controllable focal conic texture area of the display.

2. The display as in claim 1 wherein the predetermined polarity means that the cholesteric cell structure has an opposite polarity to the circular polarizer and to the cholesteric coloring film when the cholesteric material is chosen in a visible reflective wave bend

3. The display as in claim 1 wherein the predetermined polarity also means that cholesteric cell structure has the same polarity as the circular polarizer and the cholesteric coloring film when the cholesteric material is chosen in an invisible reflective wave bend.

4. The display as in claim 1 wherein the cholesteric liquid crystal material has a predetermined wave bend means an infrared Bragg reflection, which provides an optical compensation solution to the color shift of the cholesteric color filter.

5. The display as in claim 1 wherein the solid cholesteric coloring film is positioned on the top of the transparent conductive patterning layer and directly contact with the cholesteric liquid crystal material.

6. The display as in claim 1 wherein the solid cholesteric coloring film is positioned between the transparent conductive patterning layer and the display's substrate.

7. The display as in claim 1 wherein the cholesteric coloring film is a polymerized pure cholesteric red, green and blue microstructure.

8. The display as in claim 1 wherein the cholesteric coloring film is a polymerized hybrid red, green and blue microstructure including cholesteric material and at least one type of dyestuff.

9. The display as in claim 8 wherein the dyestuff has a predetermined wave bend, which enables the cholesteric coloring film, at the same location, not only reflects a color in a given polarity but also transmits the same color but in opposite polarity.

10. The display as in claim 1 further including a back light component which makes a dual-working mode full color display, i.e., in a bright ambient light condition, the display works as a reflective display, while in a dark ambient light condition, the display works as a transmissive backlit display.

11. The display as in claim 10 wherein the transmissive backlit display is a reverse mode display of the reflective display.

12. A non-absorptive color projection display comprising:
a. a cholesteric coloring patterned film,
b. a projection lens system with a predetermined collecting angle,
c. a back light system,
d. a housing structure,
e. a plurality of transparent conductive patterned substrates juxtaposed to form a cell structure,
f. a cholesteric liquid crystal material with an infrared intrinsic wave bend and with a controllable planar texture and a controllable focal conic texture respectively,
wherein the non-absorptive cholesteric coloring film is positioned to the inside of the transparent conductive patterned substrate opposite to the viewing side with the color pattern corresponding to the conductive pattern of the substrate, while the cell structure, including the cholesteric liquid crystal material, is positioned between the projection lens system and the back light system with a properly equipped housing and space,
whereby at least one primary color will be projected from the controllable planar texture area of the display and an optical dark state will be generated from the controllable focal conic texture area of the display.

13. The color projection display as in claim 12 wherein the projection display is a multi-purpose overhead projector.

14. The color projection display as in claim 13 wherein the multi-purpose overhead projector is capable of projecting a transparent film when the display pre-set in the controllable planar texture; and of projecting at least a portion of the transparent film when the display is programmed with a partial planar texture area and a partial focal conic texture area.

15. The color projection display as in claim 12 is an ultra-compact non-dichroic portable projector.

16. The color projection display as in claim 12 is a super bright color projector due to light recycling of the cholesteric coloring film.

17. A cholesteric coloring film manufacturing process comprising:
a. building-up a black wall structure on a permanent substrate with a predetermined dimension and configuration,
b. laminating a temporary plastic alignment film onto the black wall structure to form at least one opening channel and an enclosed channel corresponding to a display pixel area,
c. filling a cholesteric UV-curable coloring formulation into the opening channel and being polymerized,
d. delaminating the temporary plastic alignment film and disclosing the enclosed channel,
e. laminating the temporary plastic alignment film again while nip-filling the disclosed channel with the coloring formulation and being properly polymerized,
f. disregarding the temporary plastic alignment film by peeling off it from the coloring microstucture,
wherein the first primary color is filled and cured in the first filling channel and the second primary color is filled and cured in the second filling channel and the third primary color is filled and cured in the disclosed channel, each primary color is substantially pre-mixed and it may or may not being fine-tuned by temperature before polymerized,
whereby a solid cholesteric coloring film structure is constructed.

18. The cholesteric coloring film manufacturing process as in claim 17 wherein the cholesteric UV-curable coloring formulation is a mixture of an UV initiator, chiral nematic liquid crystal, cholesteric monomer, nematic monomer and spacing material.

19 The cholesteric coloring film manufacturing process further including laminating a permanent transparent conductive layer on the top of cholesteric coloring microstructure while nip-filling the disclosed channel with the coloring formulation and finally curing properly into a integrated display substrate structure.

20 The cholesteric coloring film manufacturing process as in claim 17 wherein the first, second and the third channel can be also filled with the coloring formulation simultaneously by the nip-filling lamination process.
